(19) United States
(12) Patent Application Publication
(10) Pub. No.: US 2013/0120111 A1
(43) Pub. Date: May 16, 2013

(54) KEYLESS ENTRY SYSTEM AND CONTROL METHOD THEREOF

(71) Applicants: Chun-Yi SUN, Taoyuan Hsien (TW); Jon-Hong Lin, Taoyuan Hsien (TW); Wei-Chun Lin, Taoyuan Hsien (TW)

(72) Inventors: Chun-Yi SUN, Taoyuan Hsien (TW); Jon-Hong Lin, Taoyuan Hsien (TW); Wei-Chun Lin, Taoyuan Hsien (TW)

(21) Appl. No.: 13/447,794

(22) Filed: Apr. 16, 2012

(30) Foreign Application Priority Data
Nov. 15, 2011 (TW) 100141535

(51) Int. Cl. G06K 19/00

(52) U.S. Cl. 340/5.61

(57) ABSTRACT

A keyless entry system comprises a resonant unit, a control unit and a portable device. The resonant unit is disposed to at least one door and generates a sensing signal when sensing a user approaching or touching the door. The control unit receives the sensing signal and controls the resonant unit to transmit a first authentication signal. The portable device receives the first authentication signal and transmits a second authentication signal according to the first authentication signal. The control unit receives the second authentication signal and controls the door according to the second authentication signal.

### CROSS REFERENCE TO RELATED APPLICATIONS

This Non-provisional application claims priority under 35 U.S.C. §119(a) on Patent Application No(s). 100141535 filed in Taiwan, Republic of China on Nov. 15, 2011, the entire contents of which are hereby incorporated by reference.

### BACKGROUND OF THE INVENTION

1. Field of Invention

The invention relates to an entry system and a control method thereof and, in particular, to a keyless entry system and a control method thereof.

2. Related Art

In recent years, the adoption of keyless entry system for controlling the car door or the house door is more and more widespread.

As shown in FIG. 1, a conventional keyless entry system 1 for cars includes a trigger device 11, a control device 12, a portable device 13 and a lock actuator 14. The control device 12 includes a control circuit 121, a transmission circuit 122, a transmission antenna 123, a receiving antenna 124 and a receiving circuit 125.

When a user O approaches or touches the trigger device 11, it generates a trigger signal TS to start an identification procedure. When the control circuit 121 receives the trigger signal TS, an identification signal AS is transmitted by the transmission circuit 122 and the transmission antenna 123 through the control of the control circuit 121. Then, the portable device 15 (e.g. a car key carried by the user O) receives and decodes the identification signal AS. If the identification signal AS is identified as correct, the portable device 15 will transmit a recognition signal MS to the control device 12 by a high-frequency antenna of the portable device 15. The recognition signal MS is received by the receiving antennal 124 and the receiving circuit 125. When the control circuit 121 decodes and determines the recognition signal MS is correct, the control circuit 121 will control the lock actuator 14 to transmit an open signal OS for opening the car door. By the keyless entry system 1, the user can open the car door without using a physical car key.

At present, a contact-type sensor or a photo sensor is used as the trigger device 11 to sense whether the user O approaches or touches the trigger device 11; hence, the procedure of determining whether the trigger of the trigger device 11 occurs or not is more complicated. Besides, in the prior art, the control device 12 needs the transmission antenna 123 for transmitting the identification signal AS, so the cost of the keyless entry system 1 is higher and the control procedure thereof is complicated.

Therefore, it is an important subject to provide a keyless entry system and a control method thereof that can decrease the cost and simplify the control procedure.

### SUMMARY OF THE INVENTION

In view of the foregoing subject, an object of the invention is to provide a keyless entry system and a control method thereof that can decrease the cost and simplify the control procedure.

To achieve the above objective, the present invention discloses a keyless entry system which comprises a resonant unit, a control unit and a portable device. The resonant unit is disposed to at least one door and generates a sensing signal when sensing a user approaching or touching the door. The control unit receives the sensing signal and controls the resonant unit to transmit a first authentication signal. The portable device receives the first authentication signal and transmits a second authentication signal according to the first authentication signal. The control unit receives the second authentication signal and controls the door according to the second authentication signal.

In one embodiment, the resonant unit is a resonator. The resonant unit comprises at least an inductor and at least a capacitor connected in series or in parallel.

In one embodiment, the control unit comprises an oscillating circuit which is electrically connected with the resonant unit and receives the sensing signal for generating an oscillating frequency. The control unit further comprises a control circuit which determines whether the resonant unit transmits the first authentication signal according to the oscillating frequency. The control circuit controls the oscillating circuit to generate a voltage signal, so that the resonant unit transmits the first authentication signal. The control unit further comprises a second wireless receiving unit for receiving the second authentication signal. The control circuit determines whether to transmit a control signal for opening the door according to the second authentication signal.

In one embodiment, the portable device comprises a first wireless receiving unit for receiving the first authentication signal, and a wireless transmission unit for transmitting the second authentication signal.

To achieve the above objective, the present invention discloses a control method of a keyless entry system for controlling to open a door and comprises steps of: transmitting a sensing signal by a resonant unit when sensing a user approaching or touching the door or the resonant unit; receiving the sensing signal by a control unit; controlling, by the control unit, the resonant unit to transmit a first authentication signal; transmitting a second authentication signal after receiving the first authentication signal; and controlling, by the control unit, the door after receiving the second authentication signal. The resonant unit is a resonator.

In one embodiment, the control method further comprises: generating an oscillating frequency by an oscillating circuit according to the sensing signal.

In one embodiment, the control method further comprises: transmitting the first authentication signal if the oscillating frequency is different from a natural resonant frequency; and not transmitting the first authentication signal if the oscillating frequency equals the natural resonant frequency.

In one embodiment, the control method further comprises: receiving the first authentication signal by a portable device; and transmitting the second authentication signal by the portable device.

In one embodiment, the control method further comprises: opening the door if the second authentication signal is the same as an effective signal; and not opening the door if the second authentication signal is different from the effective signal.

As mentioned above, in the keyless entry system and the control method thereof of the invention, a resonant unit transmits the first authentication signal when sensing a user approaching or touching the door or the resonant unit. According to the first authentication signal, a portable device transmits the second authentication signal, and a control unit controls the door according to the second authentication signal. Compared with the prior art, the keyless entry system of the invention can sense whether a user approaches or touches without using a trigger device, and can transmit the identification signal without using an additional transmission antenna. Besides, because the resonant unit of the invention replaces the trigger device and the transmission antenna, the control procedure of the keyless entry system is simplified. Therefore, the keyless entry system and the control method thereof of the invention have advantages of cost down and simple procedure.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a block diagram of a conventional keyless entry system for cars;

FIG. 2 is a block diagram of a keyless entry system of a preferred embodiment of the invention;

FIGS. 3A and 3B are schematic diagrams showing equivalent circuits of the resonant unit;

FIG. 4 is another block diagram of the keyless entry system of the preferred embodiment of the invention; and

FIG. 5 is a flow chart of a control method of the keyless entry system of the preferred embodiment of the invention.

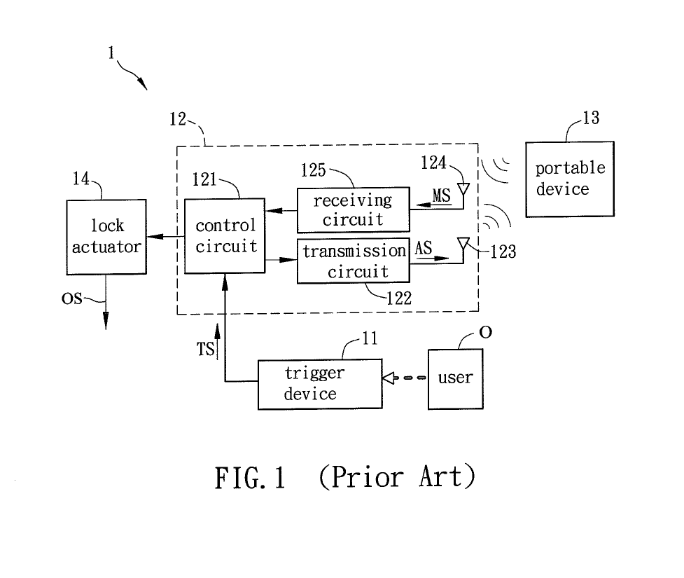

### DETAILED DESCRIPTION OF THE INVENTION

The present invention will be apparent from the following detailed description, which proceeds with reference to the accompanying drawings, wherein the same references relate to the same elements.

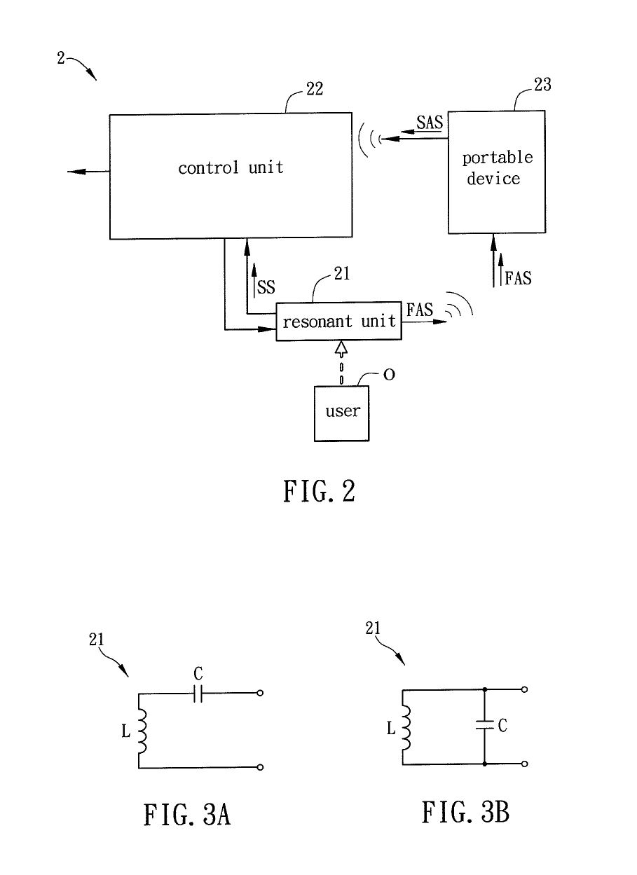

FIG. 2 is a block diagram of a keyless entry system 2 of a preferred embodiment of the invention.

The keyless entry system 2 includes a resonant unit 21, a control unit 22 and a portable device 23. The portable device 23 is a portable object for the user O (a car-owner or a house-owner for example), and can be a key, a remote controller and so on. The keyless entry system 2 is suitable for the control of a car door, a house door or the access to any device. In the embodiment, the keyless entry system 2 is applied to the control of a car door for example.

The resonant unit 21 is disposed to at least one door. In this case, the resonant unit 21 is disposed at the door handle of a car, so that the keyless entry system 2 can control to open the car door. The resonant unit 21 can generate a sensing signal SS when sensing a user O approaching or touching the door. The sensing signal SS is received by the control unit 22.

FIGS. 3A and 3B are schematic diagrams showing different equivalent circuits of the resonant unit 21. The resonant unit 21 can be a dielectric resonator (DR), and the equivalent circuit thereof includes an inductor L and a capacitor C connected in series or in parallel. To be noted, the aspects shown in FIGS. 3A and 3B are just instanced, and the circuit of the resonant unit 21 can be adjusted for fitting the practical requirement.

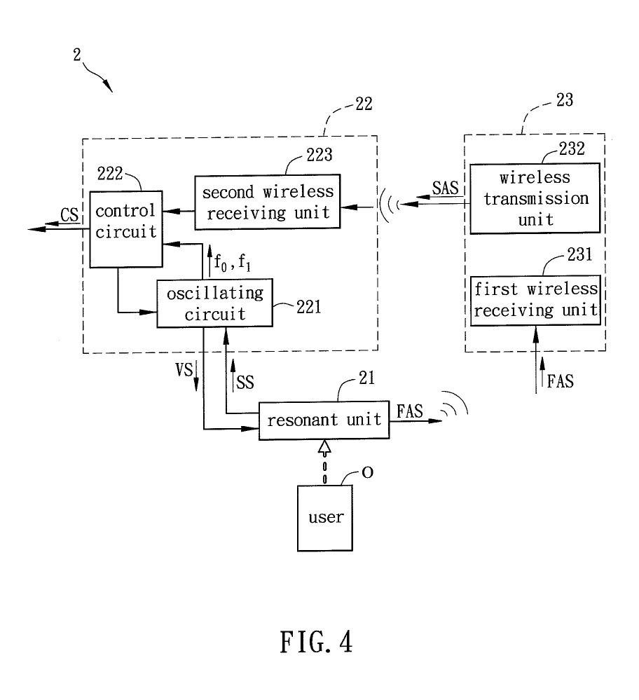

As shown in FIGS. 3A, 3B and 4, the control unit 22 includes an oscillating circuit 221 which is electrically connected to the resonant unit 21. Herein, the oscillating circuit 221 is a voltage controlled oscillator (VCO). When the user O doesn't approach or touch the resonant unit 21, the resonant unit 21 makes the oscillating circuit 221 generate a natural resonant frequency f0. The natural resonant frequency f0 equals ½π\sqrt{LC}, wherein L represents the inductance value of the inductor L, and C represents the capacitance of the capacitor C. Otherwise, when the user O approaches or touches the resonant unit 21, the inductance value and capacitance of the resonant unit 21 will change as well as the time constant because of the human induction. Accordingly, the resonant unit 21 transmits a sensing signal SS to the oscillating circuit 221, and the oscillating circuit 221 generates an oscillating frequency f1 according to the sensing signal SS.

The control unit 22 further includes a control circuit 222 which determines whether a first authentication signal FAS is transmitted by the resonant unit 21 according to the oscillating frequency f1. The control circuit 222 compares the oscillating frequency f1 and natural resonant frequency 10. If the oscillating frequency f1 equals the natural resonant frequency f0, it means the user O doesn't approach or touch the resonant unit 21 and the user doesn't want to open the car door, so the control circuit 222 doesn't control the resonant unit 21 to transmit the first authentication signal FSA. Otherwise, if the oscillating frequency f1 is different from the natural resonant frequency f0, it means the user O approaches or touches the resonant unit 21 and also the user wants to open the car door, so the control circuit 222 controls the resonant unit 21 to transmit the first authentication signal FSA. In the embodiment, the control circuit 222 controls the resonant 21 to transmit the first authentication signal FSA by controlling the oscillating circuit 221 to transmit a voltage signal VS to the resonant unit 21. Herein, the first authentication signal FSA is a low frequency signal. Because the resonant unit 21 is a dielectric resonator, it can act as a dielectric resonant antenna transmitting the first authentication signal FSA wirelessly, which means the resonant unit 21 is used as a transmission antenna.

The portable device 23 can receive the first authentication signal FSA from the resonant unit 21, and transmit a second authentication signal SSA according to the first authentication signal FSA. The portable device 23 includes a first wireless receiving unit 231 and a wireless transmission unit 232. The first wireless receiving unit 231 receives the first authentication signal FSA. After the portable device 23 decodes the first authentication signal FSA, the wireless transmission unit 232 transmits the second authentication signal SSA according to the decoded signal. Herein, the second authentication signal SSA is a high frequency signal. To be noted, the keyless entry system 2 is used to control whether the user O can enter the car door or the house door, so the user O must be near the car or the house when the first authentication signal FSA and the second authentication signal SSA are generated. Therefore, the signal transmission power of the whole system can be decreased.

The control unit 22 further includes a second wireless receiving unit 223 which receives the second authentication signal SAS transmitted by the wireless transmission unit 232. The control circuit 222 determines whether to transmit a control signal CS for opening the door according to the second authentication signal SAS. The second wireless receiving unit 223 receives the second authentication signal SAS and transmits it to the control circuit 222. Then, the control circuit 222 decodes the second authentication signal SAS. If the second authentication signal SAS is the same as an effective signal stored or built in the control unit 22, the control circuit 222 transmits a control signal CS so that a lock actuator (not shown) is controlled to open the car door. Otherwise, if the second authentication signal SAS is not the same as the effective signal, it means the second authentication signal SAS is an ineffective signal and the user O approaching or touching the door is not a real owner of the car or the house. Therefore, the control circuit 222 will not transmit the control signal CS, and of course, the door is not opened.

In detail, the definition of the effective signal is as below. The control circuit 222 receives and decodes the second authentication signal SAS. If the user O is a real owner of the car or the house, the decoded signal will equal the code store or built in the control circuit 222, and then the control unit 22 can determine the second authentication signal SAS generated by the portable device 23 is an effective signal. Therefore, the control signal CS is transmitted to the lock actuator for opening the car door. On the contrary, the second authentication signal SAS is an ineffective signal.

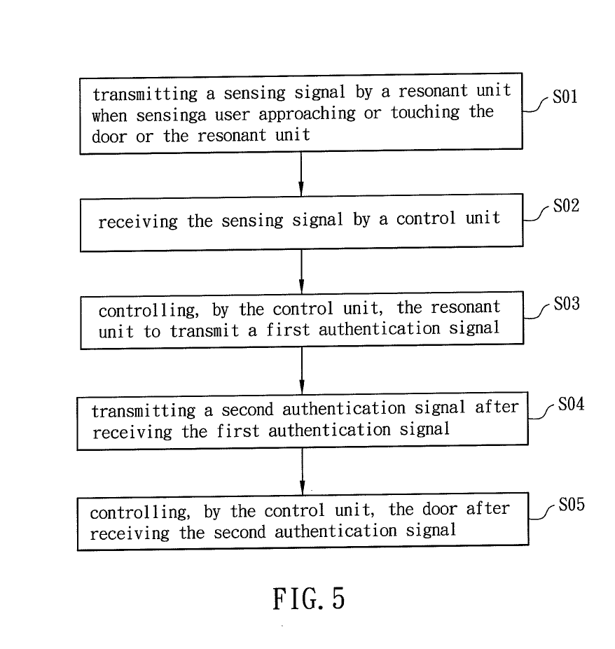

As shown in FIGS. 4 and 5, a control method of the keyless entry system 2 is illustrated as below. FIG. 5 is a flow chart of the control method of the keyless entry system 2. The control method of the keyless entry system 2 includes steps S01 to S05.

The step S01 is to transmit a sensing signal SS by a resonant unit 22 when sensing a user O approaching or touching the door or the resonant unit 22. The resonant unit 21 is a dielectric resonator. When the user O approaches or touches the door or the resonant unit 22, the time constant of the resonant unit 21 changes due to the human induction. Then, the resonant unit 21 generates the sensing signal SS, and the oscillating circuit 221 of the control unit 22 can, according to the sensing signal SS, generate an oscillating frequency f1 different from the natural resonant frequency f0.

The step S02 is to receive the sensing signal SS by a control unit 22. Then, the step S03 is to control, by the control unit 22, the resonant unit 21 to transmit a first authentication signal FAS. If the oscillating frequency f1 is different from the natural resonant frequency f0, the control unit 22 controls the resonant unit 21 to transmit the first authentication signal FAS. If the oscillating frequency f1 equals the natural resonant frequency f0, the resonant unit 21 doesn't transmit the first authentication signal FAS.

The step S04 is to transmit a second authentication signal SAS after receiving the first authentication signal FAS. Herein, the first authentication signal FAS is received by the first wireless receiving unit 231 of the portable device 23, and the second authentication signal SAS is transmitted by the wireless transmission unit 232 of the portable device 23 after receiving the first authentication signal FAS.

The step S05 is to control, by the control unit 22, the door after receiving the second authentication signal SAS. Herein, if the second authentication signal SAS is the same as an effective signal built in the control circuit 222, the control circuit 222 transmits the control signal CS for opening the car door. Otherwise, if the second authentication signal SAS is different from the effective signal, the control circuit 222 doesn't transmit the control signal CS so that the door is not opened.

The further technical features of the keyless entry system 2 are illustrated clearly as the above embodiments, so the detailed descriptions thereof are omitted.

In summary, in the keyless entry system and the control method thereof of the invention, a resonant unit transmits the first authentication signal when sensing a user approaching or touching the door or the resonant unit. According to the first authentication signal, a portable device transmits the second authentication signal, and a control unit controls the door according to the second authentication signal. Compared with the prior art, the keyless entry system of the invention can sense whether a user approaches or touches without using a trigger device, and can transmit the identification signal without using an additional transmission antenna. Besides, because the resonant unit of the invention replaces the trigger device and the transmission antenna, the control procedure of the keyless entry system is simplified. Therefore, the keyless entry system and the control method thereof of the invention have advantages of cost down and simple procedure.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A keyless entry system, comprising:
a resonant unit disposed to at least one door and generating a sensing signal when sensing a user approaching or touching the door;
a control unit receiving the sensing signal and controlling the resonant unit to transmit a first authentication signal; and
a portable device receiving the first authentication signal and transmitting a second authentication signal according to the first authentication signal, wherein the control unit receives the second authentication signal and controls the door according to the second authentication signal.

2. The keyless entry system as recited in claim 1, wherein the resonant unit is a resonator.

3. The keyless entry system as recited in claim 1, wherein the resonant unit comprises at least an inductor and at least a capacitor connected in series or in parallel.

4. The keyless entry system as recited in claim 1, wherein the control unit comprises an oscillating circuit which is electrically connected with the resonant unit and receives the sensing signal for generating an oscillating frequency.

5. The keyless entry system as recited in claim 4, wherein the control unit further comprises a control circuit which determines whether the resonant unit transmits the first authentication signal according to the oscillating frequency.

6. The keyless entry system as recited in claim 5, wherein the control circuit controls the oscillating circuit to generate a voltage signal, so that the resonant unit transmits the first authentication signal.

7. The keyless entry system as recited in claim 1, wherein the portable device comprises a first wireless receiving unit for receiving the first authentication signal, and a wireless transmission unit for transmitting the second authentication signal.

8. The keyless entry system as recited in claim 1, wherein the control unit further includes a second wireless receiving unit for receiving the second authentication signal.

9. The keyless entry system as recited in claim 5, wherein the control circuit determines whether to transmit a control signal for opening the door according to the second authentication signal.

10. A control method of a keyless entry system for controlling to open a door, comprising steps of:
transmitting a sensing signal by a resonant unit when sensing a user approaching or touching the door or the resonant unit;
receiving the sensing signal by a control unit;
controlling, by the control unit, the resonant unit to transmit a first authentication signal;
transmitting a second authentication signal after receiving the first authentication signal; and
controlling, by the control unit, the door after receiving the second authentication signal.

11. The control method as recited in claim 10, further comprising:
generating an oscillating frequency by an oscillating circuit according to the sensing signal.

12. The control method as recited in claim 11, further comprising:
transmitting the first authentication signal if the oscillating frequency is different from a natural resonant frequency; and
not transmitting the first authentication signal if the oscillating frequency equals the natural resonant frequency.

13. The control method as recited in claim 10, further comprising:
receiving the first authentication signal by a portable device; and
transmitting the second authentication signal by the portable device.

14. The control method as recited in claim 10, further comprising:
opening the door if the second authentication signal is the same as an effective signal; and
not opening the door if the second authentication signal is different from the effective signal.

15. The control method as recited in claim 10, wherein the resonant unit is a resonator.
